(19) United States
(12) Patent Application Publication
(10) Pub. No.: US 2003/0066892 A1
(43) Pub. Date: Apr. 10, 2003

(54) System for reading text display information

(76) Inventor: Yuki Akiyama, Kawasaki-shi (JP)

Correspondence Address: REED SMITH HAZEL & THOMAS LLP, Suite 1400, 3110 Fairview Park Drive, Falls Chruch, VA, 22042, US

(21) Appl. No.: 09/972,930

(22) Filed: Oct. 10, 2001

(51) Int. Cl. G06K 7/10

(52) U.S. Cl. 235/472.01

(57) ABSTRACT

An object of the present invention is to provide a system for reading text display information, which is formed by a reader mechanism which reads information of an information recording element which is provided at an information display member such as a poster and to which necessary and/or optional information is inputted and a display portion for displaying the information.

The present invention includes an information display member such as a poster and a mobile communication system which reads an information portion of the information display member. The information display member is provided with an information recording element to which necessary and/or optional information of the information portion is inputted. A main body of the mobile communication system is provided with a reader mechanism for reading information recorded in the information recording element and a display portion for displaying the information.

### BACKGROUND OF THE INVENTION

1. Field of the Invention

The present invention relates to an information display member such as a poster and a mobile communication system for reading an information portion of the information display member. In particular, the present invention relates to a system for reading text display information which is formed by a reader mechanism for reading information of an information recording element which is provided at the information display member and to which necessary and/or optional information is inputted and a display portion for displaying the information.

2. Description of the Related Art

For example, a telephone number, a fax number, so-called domain information such as a URL on the Internet or an e-mail address are written into text display information such as a poster which now can be seen anywhere in towns.

Further, there has been provided text display information which is considered to be necessary in our life such as time tables at stations, statements of virtues in spas or the like.

In order to obtain such information, paper medium such as a memo pad and means to write with such as a ball-point pen are usually needed.

Alternatively, there has been utilized a method in which the information is temporarily recorded as a voice in a voice storage medium such as a tape recorder, and then used.

Further, in a case in which the information is provided with a map, a user has to write down roads and boundaries of buildings by the hand. Subsequently, when a map with image information is to be made, the shot image information and geographic information such as latitude and longitude are prepared separately. Then, the image information and the geographic information must be combined and edited.

Such work is not limited to the case in which maps are provided. For example, when a database for commodity catalogs or a clinical chart system is to be formed, images obtained by shooting commodities or patients' affected areas and codes for managing the commodities or clinical chart data are formed separately. Then, the images and the codes or the data need to be combined and edited.

However, the information written on a memo pad is difficult to read because of mistakes at the time of copying or bad handwritings. Such method is not sufficient to collect correct and detail information.

Moreover, in a case of audio recording, the information must be read on the spot. When the information is read, the information may be misread or the information may not be collected successfully because of noises. Thus, the audio recording is not sufficient to collect correct and detail information. Further, a user has to carry the voice storage medium, which suffers the user.

### SUMMARY OF THE INVENTION

In order to solve the above-described problems, an object of the present invention is to provide a system for reading text display information, which is formed by an information display member such as a poster and a mobile communication system for reading an information portion of the information display member. In particular, an object of the present invention is to provide a system for reading text display information, which is formed by a reader mechanism for reading information of an information recording element which is provided at the information display member and to which necessary and/or optional information is inputted and a display portion for displaying the information.

In a preferred embodiment of the present invention to achieve such object, another object of the present invention is to provide the system for reading text display information in which the information recording element is storage means such as an IC chip and/or a bar code.

Still another object of the present invention is to provide the system for reading text display information which is configured such that information stored in the reader mechanism can be transferred to a mobile communication system other person carries and/or to a system having a function of communication terminal.

A still another object of the present invention is to provide the system for reading text display information which is configured such that the information stored in the reader mechanism can be connected to a net line from LAN.

A still another object of the present invention is to provide the system for reading text display information which is configured such that the information stored in the reader mechanism can be recorded in a recording medium such as a server system.

A still another object of the present invention is to provide the system for reading text display information in which text information and/or audio information and/or image information are inputted to the information recording element.

A still another object of the present invention is to provide the system for reading text display information in which the information stored in the reader mechanism can be copied.

A still another object of the present invention is to provide the system for reading text display information which includes means for displaying in an enlarged manner a desired portion of the information displayed on the display portion at a main body of the mobile communication system.

In order to solve the above-described problems, an object of the present invention is to provide a system for reading text display information in which an information display member is provided with an information recording element to which necessary and/or optional information is inputted and a signal member for notifying an existence of the information recording element, and a main body of a mobile communication system is provided with a reader mechanism for reading information recorded in the information recording element, a display portion for displaying the information and means for detecting the signal member.

A still another object of the present invention is to provide the system for reading text display information in which the signal member such as an audio signal, an on-and-off light signal, a signal displayed by characters or figures is used alone or in combinations thereof.

A still another object of the present invention is to provide the system for reading text display information in which the information recording element has a function of counting the number that information has been read.

A still another object of the present invention is to provide the system for reading text display information in which the above-mentioned number of counts can be recorded in a recording medium such as a server system.

An overall characteristic of the present invention is that the present invention is formed by an information display member such as a poster with which an information recording element such as an IC chip and/or a bar code is provided and a mobile communication system which has a reader mechanism for reading information of the information recording element which is provided at the information display member and to which necessary and/or optional information is inputted and a display portion for displaying the information, and information inputted in advance in the information recording element, for example information stored in a bar code or in an IC chip can be read by using the reader mechanism.

Another characteristic of the present invention is that information stored in the reader mechanism can be transferred to a mobile communication system other person carries and/or to a system having a function of communication terminal.

A still another characteristic of the present invention is that the information stored in the reader mechanism can be connected to a net line from LAN.

A still another characteristic of the present invention is that the information stored in the reader mechanism can be recorded in a recording medium such as a server system.

A still another characteristic of the present invention is that text information and/or audio information and/or image information are inputted to the information recording element.

A still another characteristic of the present invention is that the information stored in the reader mechanism can be copied.

A still another characteristic of the present invention is that there is provided means for displaying in an enlarge manner the information displayed on the display portion at a main body of the mobile communication system.

A still another characteristic of the present invention is that the information display member is provided with an information recording element to which necessary and/or optional information is inputted and a signal member for notifying an existence of the information recording element, and the mobile communication system is provided with a reader mechanism for reading information recorded in the information recording element, a display portion for displaying the information and means for detecting the signal member.

A still another characteristic of the present invention is that the signal member such as an audio signal, an on-and-off light signal, a signal displayed by characters or figures is used alone or in combinations thereof.

A still another characteristic of the present invention is that the information recording element is configured to have a function of counting the number that information has been read.

A still another characteristic of the present invention is that the number of counts can be recorded in a recording medium such as a server system.

The present invention has other superior objects, characteristics, operations and effects which will be described in an embodiment hereinafter.

### BRIEF DESCRIPTION OF THE DRAWINGS

FIG. 1 is a schematic flow chart of a system for reading information of an information recording element which is provided at an information display member and to which necessary and/or optional information is inputted by using input means provided in a mobile communication system.

FIG. 2 is a view of an example of a mobile communication system provided with a reader for reading information relating to the present invention.

FIG. 3 is a schematic flow chart 1 showing an overall configuration of the present invention.

FIG. 4 is a view of an example of a case in which an enlargement function is used in a display portion provided at a mobile communication system.

FIG. 5 is a schematic flow chart 2 showing an overall configuration of the present invention.

FIG. 6 is a view showing an example of a memory of an IC chip.

FIG. 7 is a view showing an example of a relationship between an IC chip and an antenna.

FIG. 8 is an example 1 of a menu screen displayed on a PC.

FIG. 9 is an example 2 of a menu screen displayed on a PC.

FIG. 10 is an example 3 of a menu screen displayed on a PC.

FIG. 11 is an example 4 of a menu screen displayed on a PC.

FIG. 12 is an example 5 of a menu screen displayed on a PC.

FIG. 13 is a view of an example of a case in which an IC chip is used as an information recording element which is provided at an information display member and to which necessary and/or optional information is inputted.

FIG. 14 is a view showing examples of two-dimensional bar codes.

### DESCRIPTION OF THE PREFERRED EMBODIMENTS

One embodiment of the present invention will be described hereinafter with reference to the drawings. This embodiment is formed by an information display portion (A) such as a poster and a mobile communication system (B). The information display member (A) such as a poster is provided with an information recording element (R) to which necessary and/or optional information (G) is inputted. Various information can be recorded and stored by using a reader mechanism (V) which is provided at the mobile communication system (B) and which reads information (G) recorded in advance in the information recording element (R). If necessary, any of the recorded information is retrieved and outputted on a display portion (E) provided in the mobile communication system (B).

The information display member (A) such as a poster is provided with the information recording element (R) to which necessary and/or optional information (G) is inputted. Examples of the information recording element include storage means such as an IC chip (S) and/or a bar code (T).

Examples of the necessary and/or optional information (G) stored in the information recording element (R) include, for example, in a case of a restaurant, various types of information to be informed a user such as a name of the restaurant, a zip code, a telephone number, a fax number, a shop hour, a URL or a mail address (domain), image information such as a map showing a route to the restaurant, photographs of dishes or the like, and audio information such as a voice guide, a background music (BGM) or the like.

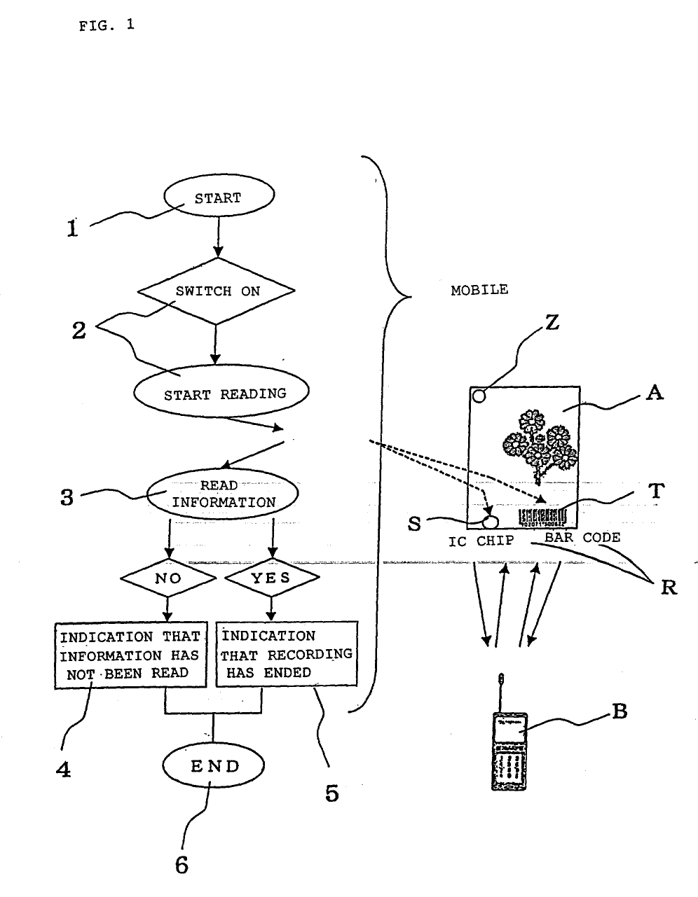

One example of an IC chip used in this embodiment of the present invention is described. In FIG. 1, reference letter (S) designates an IC chip (integrated circuit). The IC chip is formed in an extremely thin film having a size of 1 cm×1 cm.

The IC chip (S) used in the embodiment of the present invention is provided with a microcomputer (CPU). The microcomputer includes an IC card operation system therein. Further, the microcomputer can carry out an encryption processing such as DES, RSA, ECC or the like. Moreover, the microcomputer has a large storage capacity because of a large memory of 1K to 16 KB. In the microcomputer, communication between reader mechanisms to be described later can be carried out or can be locked with encrypted instructions.

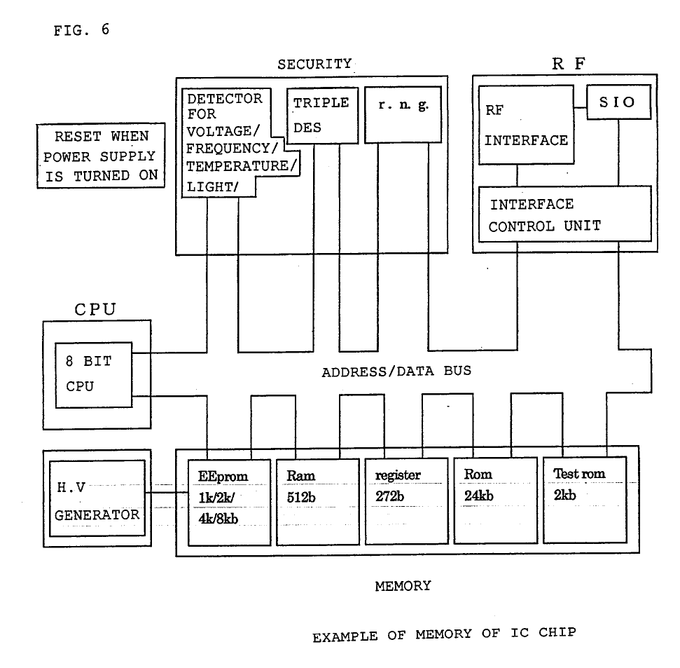

FIG. 6 shows an example of a block diagram of an interior configuration of the IC chip (S). The IC chip (S) is standardized by International Organization for Standardization (ISO) as 13.56 MHZ Standard 14443. Thus, details of the IC chip (S) will be omitted. The IC chip (S) is referred to as a combination IC card which can be used for both non-contact information processing and contact information processing.

The IC chip (S) does not require a battery. The write cycle of the IC chip (S) is 100,000 cycles. A communication distance between a reader mechanism to be described later and the IC chip is usually about 10 cm, but the distance can be set freely.

At lest an electronic circuit for storing the information (G) and a device for outputting the information (G) as a signal to a reader mechanism which is provided at the mobile communication system (B) and will be described later are inputted to the IC chip (S).

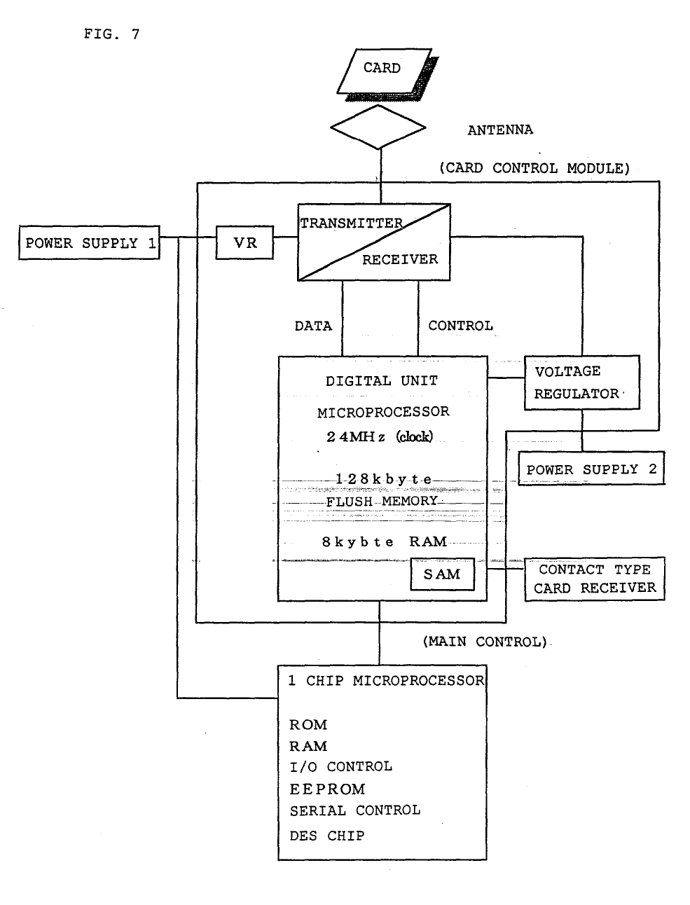

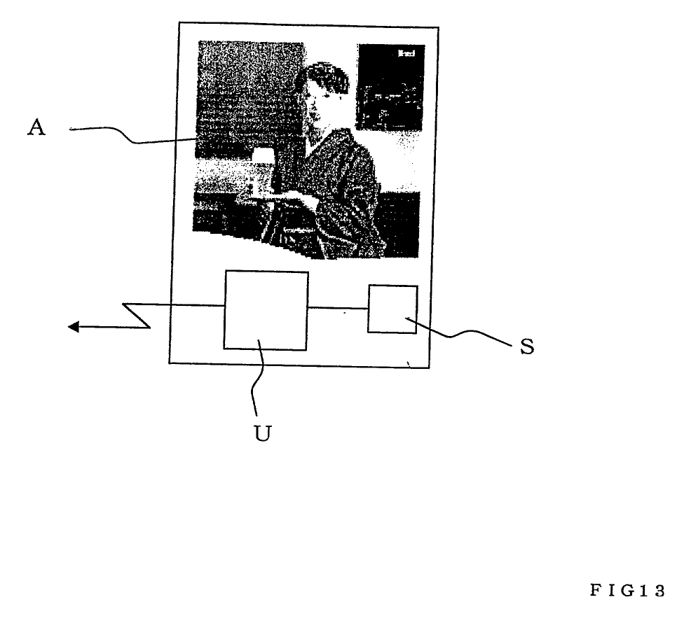

A coil antenna is used for communication. As the IC chip (S) used for a description of the present embodiment, an IC chip which includes the coil antenna (U) therein and can supply electric power by electric waves is used. Currently, IC chips in which a coil is built appear in a market. For example, as shown in FIG. 13, a coil antenna (U) may be provided at the information display member (A). FIG. 7 shows an example of the relationship between the IC chip (S) and the antenna (U), but the present invention is not limited to the example.

Equipments which are necessary for inputting information to the IC chip (S) can be selected from conventional electronic equipments. In the present embodiment, a case of using an ordinary personal computer will be used as an example.

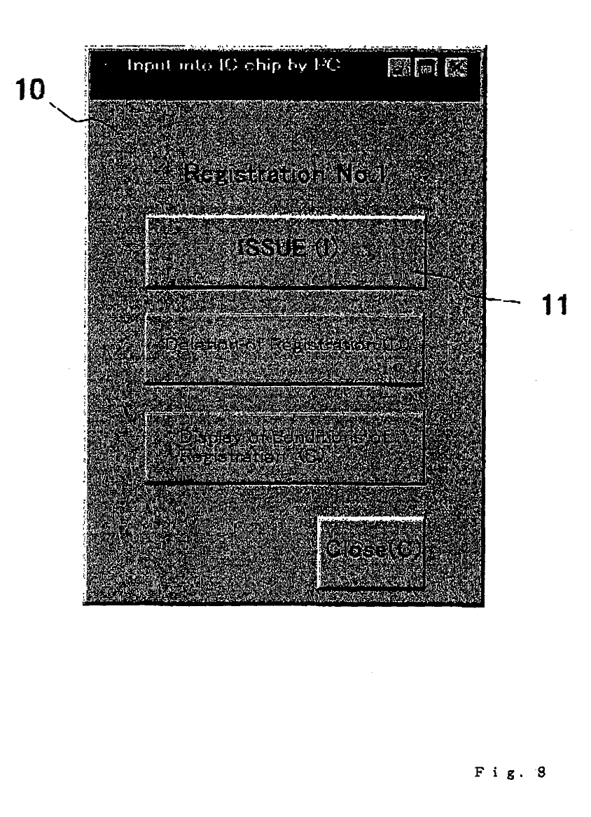

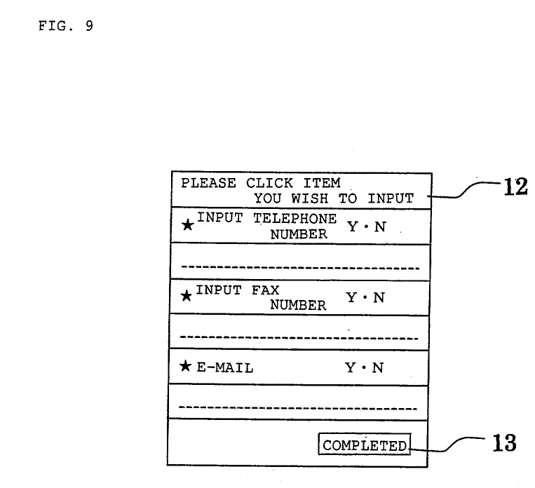

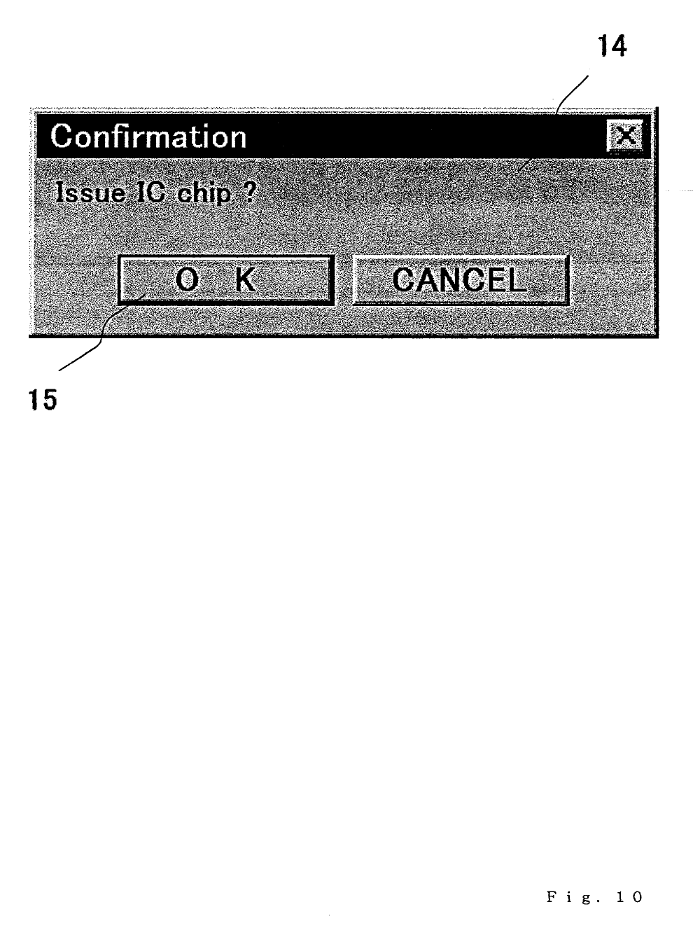

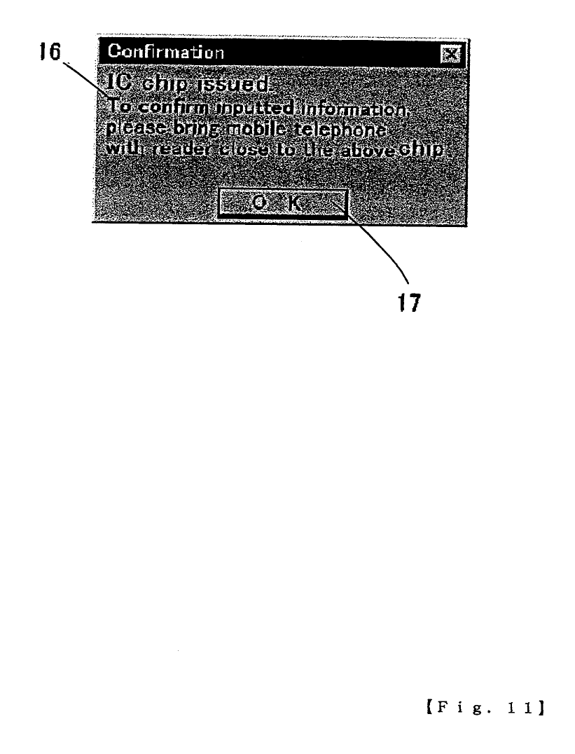

Firstly, an initial screen (10) shown in FIG. 8 is displayed on a screen of a personal computer. Then, if a user clicks issue (11), a screen (12) for input shown in FIG. 9 is displayed. A user inputs the information (G) that the user wants to inform a customer such as a telephone number, a fax number or the like in accordance with instructions of the screen. When all of the information has been inputted in appropriate columns, a user clicks end (13). As a result, a screen (14) shown in FIG. 10 is displayed. If a user clicks OK (15), a screen (16) shown in FIG. 11 is displayed and a message “An IC chip is issued. To confirm inputted information, please bring a mobile telephone with a reader to be close to the above chip.” is displayed. If necessary, a user can confirm the inputted the information in accordance with a display of a screen, but the present invention can be carried out without effecting the confirmation operation. Thereafter, if a user clicks OK (17), a work is ended.

Data of the IC chip (S) inputted as described above is transmitted to an IC chip by using a known appropriate reader/writer. In this way, data input to the IC chip (S) has been completed.

Detailed description of a spec of the IC chip (S) used for the description of the present embodiment will be omitted. The IC chip (S) includes a CPU therein. An EEPROM of the IC chip (S) has a size of 1 to 16K and a ROM thereof has a size of 6 to 20K. Entire RAM in the IC chip (S) can be used. A operating system of the IC chip (S) is COS.

An example of a bar code used in this embodiment of the present invention will be described. In FIG. 1, reference letter (T) designates a generally used bar code.

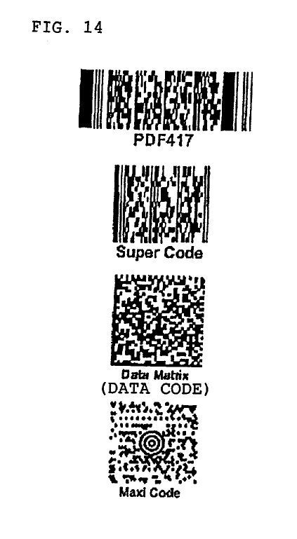

There has been widely known that a bar code which is developed in the United States and is used as easy input means for computers is applied practically to a POS system or an FA system and is making a progress. Conventionally, a bar code referred to as an one-dimensional bar code has been widely used. In the present invention, the present embodiment includes an use of a mass two-dimensional bar code (data matrix) as a next generation bar code. FIG. 14 shows actual examples of a two-dimensional bar code.

Here, advantages of the two-dimensional bar code are described below.

1. As compared with a conventional bar code, a two-dimensional bar code can be printed on a smaller space. Specifically, a two-dimensional bar code can be made such that a density thereof is 1/45 or less of an one-dimensional bar code. Information of around 16 figures can be inputted into a two-dimensional bar code having a size 2 mm×2 mm.

2. A large amount of information (data) can be inputted (encoded) into a two-dimensional bar code. Specifically, most two-dimensional bar codes have a capacity of 2,000 bytes or more. Thus, photographs and images of maps can be stored easily in a two-dimensional bar code.

3. An error correction function is included in a two-dimensional bar code. The error correction function refers to as a recovery function by special mathematic means. Accordingly, a poor printed bar code or a partially broken bar code can be read correctly.

4. In a one-dimensional bar code, alphabetic characters, numerals and special marks (for example, $ and the like) can be used. In a two-dimensional bar code, in addition to such characters, numerals and marks, Japanese characters (kanji, hiragana and katakana) can also be used.

5. In a one-dimensional bar code, information (data) can be held in a horizontal direction thereof but cannot be held in a vertical direction thereof. In a two-dimensional bar bode, the information can be held in a vertical direction thereof. Thus, as a two-dimensional bar code reader, in most cases, a CCD area sensor is used. Accordingly, a two-dimensional bar code reader can read one-dimensional bar code and two-dimensional bar bode from all (360 degrees) directions.

There are two kinds of two-dimensional bar codes, that is, a stack type bar code and a matrix type bar code. The stack type bar code is formed by stacking fine one-dimensional bar codes in a vertical direction thereof. Examples of the stack type bar code include a super bar code, a PDF 417, a CODE-49 and a CODE-16K.

A matrix bar code is formed by arranging white and black matrices (cells) of information (data) in horizontal and vertical directions thereof in a mosaic pattern. Examples of the matrix bar code include a data matrix code (data code), a maxi-code and a QR code.

When such bar codes are used in the present invention, the bar codes can be used separately. Further, depending on cases, a one-dimensional bar code and a two-dimensional bar code can be used together or a one-dimensional bar code can be changed to a two-dimensional bar code.

As the information display member (A) described herein, any image information display member may be used as long as it can appeal to the user's eye. Examples of the information display member (A) include, in addition to ordinary posters at stations, roads, waiting rooms and lobbies, signboards provided on the rooftops of buildings or at walls, time tables at stations or bus stops, statements of virtues at spas, paper ads such as newspapers or magazines, picture postcards, cards, handbills, OEM commodities such as tissue papers, ads hung down in trains, information mediums for selling commodities or for providing services.

As the information display member, three-dimensional advertisements such as so-called disposable signboards, dolls which look like various kinds of animals and disposed in front of drugstores, mascot dolls which look like founders of restaurants and disposed in front of the restaurants may be included.

A description will be given specifically of a series of processes for fetching an image as image information. FIGS. 1, 3 and 5 show an operation of photographing information by using a known reader mechanism (V) provided at the mobile communication system (B) in a time series from the top to the bottom of charts.

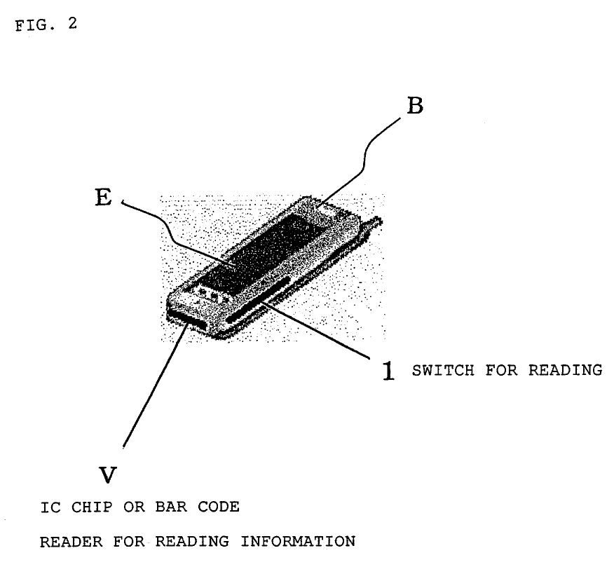

In FIG. 1, assume that there is provided the information display member (A) that a user wants to fetch. Firstly, a user directs the known reader mechanism (V) shown in FIG. 2 which is provided at the mobile communication system (B) to the information recording element (R) which is provided at an appropriate position of the information display member (A) and to which necessary and/or optional information (G) is inputted, and focuses on it.

Then, by pressing a predetermined switch button (1) provided at the mobile communication system (B), reading starts (2). At this time, information (G) is preferably fetched while being outputted on a display portion (E) provided at the mobile communication system (B). If the read information is imperfect, an indication (4) is displayed on the display portion (E) that “information has not been read”. Then, the start button (1) is pressed again and reading (3) is carried out again.

When reading (3) of the information has been completed, an indication (5) is displayed on the display portion (E) provided at the mobile communication system (B) that “recording has ended”. Then, a user confirms that the information has been recorded in a memory provided in the mobile communication system (B). In this way, photographing ends (6).

If the reading (3) of the information is to be carried out for plural times, the above-described operation is repeated for plural times, and thus work is completed.

The read information (G) as described above can be divided roughly into text information (7), image information (8) and audio information (9).

The text information (7) is usually treated, as a format for storing files, in a HTML format. HTML is an abbreviation of Hyper Text Markup Language and is one of DTDs of SGML. SGML (Standard Generalized Markup Language) is a standard which determines a method for describing a text by attaching a symbol to the text, which symbol represents a characteristic (from a logical standpoint) of the text and is referred to as a “tag”. DTD (Document Type Definition) determines a kind of the tag. HTML is considered to be one of the DTDs.

HTML has a function of associating documents in the world connected by a network with one another and of analyzing the documents on computers as beneficial information. HTML is developed not as a method for designating a text depending on an environment but as method that a software displays a document in accordance with a reader's environment by adding only a semantic location which is referred to as “a header” to the document as information in order that everyone can share the information even if environments of computers are different from one another.

Another advantage of using HTML is to facilitate a setting in a case of “reading out” a page by using a voice synthesis software for blind persons, which will be described later.

The text information (7) which has been read (3) as described above is programmed and managed so as to be given an arbitrary name or to be attached a name automatically. A management method of the text information (7) will be described later.

The text information (7) is recognized temporarily as the text information with HTML file format. By using an application software, for example, Word on an operating system Windows (Registered Trademark) supplied from Microsoft (Registered Trademark), the text information (7) can be restored in a predetermined text information format or in any of various file formats.

The image information (8) is generally treated in a JPEG format. JPEG is an efficient recording format for nature such as photographs. In JPEG, the size of a file can be compressed or transmission time on the Internet can be reduced while an image quality is maintained. JPEG is usually programmed and managed so as to provide files with arbitrary names or to attach names to the files automatically. A management method of JPEG will be described later.

The image information (8) is recognized temporarily as image information with JPEG file format. If the image information (8) is an image to which predetermined text information, GIF, BMP, or thumbnail image information is added, by using a commercially available application software on an operating system Windows (Registered Trademark) supplied from Microsoft (Registered Trademark), the image information (8) can be restored in Exif format.

For storage of the audio information (9), a WAV format has been conventionally most popular and common format for digital audio recording in Windows (Registered Trademark). The WAV format has such advantages that an operation is light and among digital audio files, a voice with the WAV format is closest to an original voice. However, the WAV format has a drawback that almost storage of a disk is occupied to record a long voice such as a music or the like. Here, in the description of the present invention, MP3 (MPEG Audio Layer-3) is considered. The MP3 has advantages as follows.

1. It is very easy to handle the MP3 because its data size is small while a sound quality is equal to that of CD.

2. Unlike a conventional standard, in the MP3, transaction can be effected on the Internet.

3. With the MP3, music data can be carried by using a portable player.

The audio information (9) which has been read (3) as described above is usually programmed and managed so as to be given an arbitrary name or to be attached a name automatically. A management method of the audio information (9) will be described later.

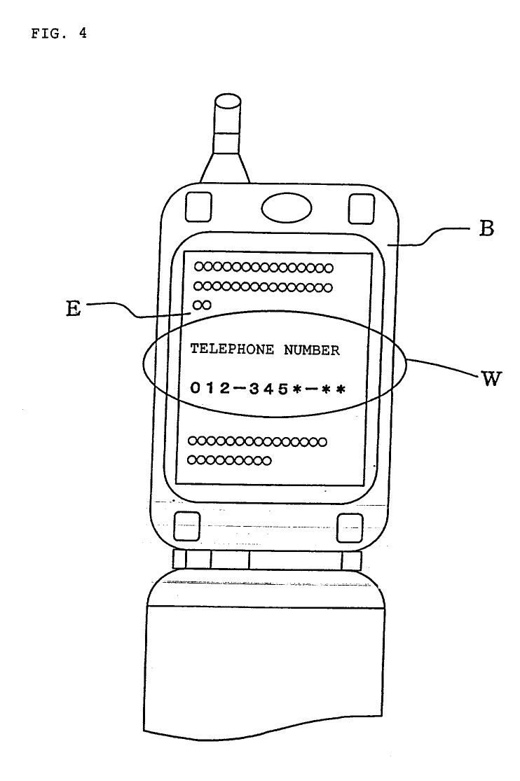

The read information (G) including the text information (7) and the image information (8) is confirmed by being outputted on the display portion (E) provided at the mobile communication system (B). As shown in FIG. 4, when a user outputs the information (G), a desired portion thereof can be displayed in an enlarged manner (W).

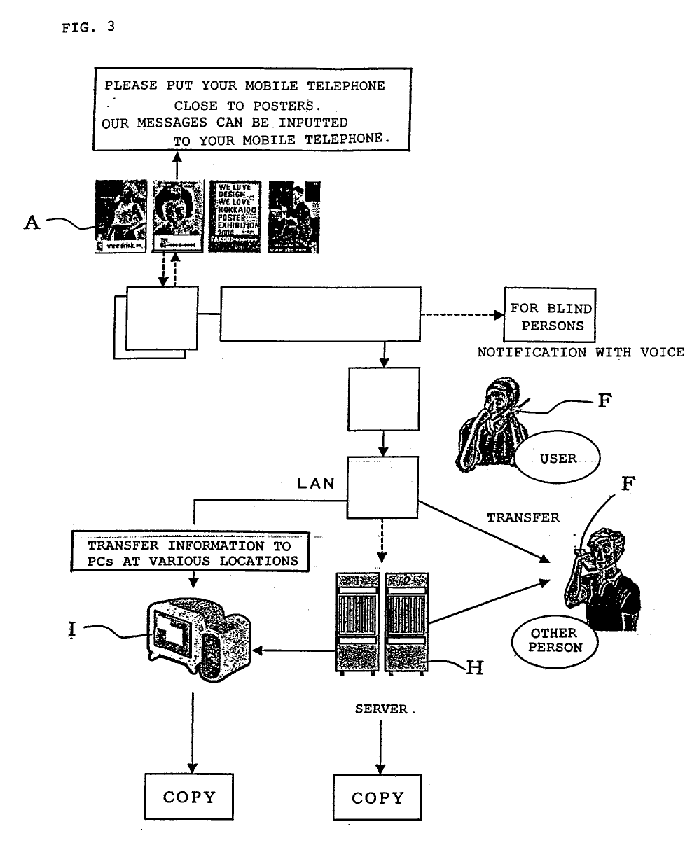

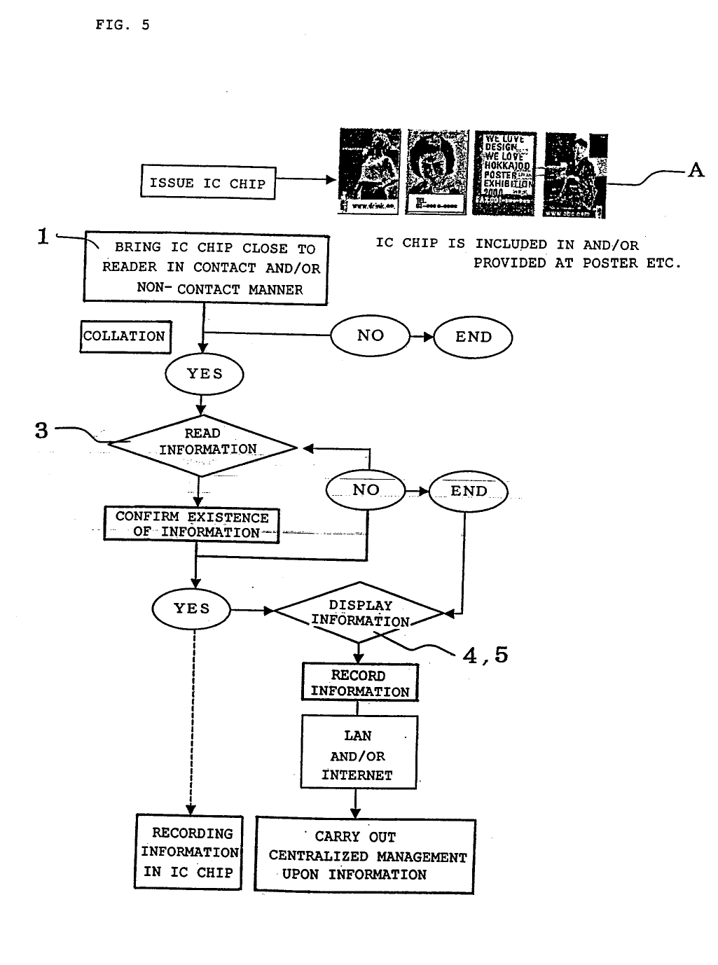

As shown in FIGS. 3 and 5, the fetched information (G) including the text information (7), the image information (8) and the audio information (9) is configured to be transferred to the mobile communication system (B) other person carries and/or to a system (F) having a function of communication terminal.

Firstly, a description will be given of a method for transferring the information to the mobile communication system (B) that other person carries and/or to the system (F) having a function of communication terminal by using the mobile communication system (B).

In a case of reading the necessary and/or optional information (G) provided at the information display member (A) by using the mobile communication system (B) having the reader mechanism (V), the fetched information (G) including the text information (7), the image information (8) and the audio information (9) is temporarily and/or permanently stored in recording means (D) of the mobile communication system (B), which is usually referred to as a memory. At this time, file names which do not overlap each other are attached automatically to respective information (G) by a program within the mobile communication system (B). Alternatively, if the information is written and managed at a user's will, text information may be inputted by using an existing ten key which is provided in advance.

Then, by transferring the information (G) including the text information (7), the image information (8) and the audio information (9) to any system having a function of communication terminal, the text information (7) such as an address or a telephone number, the image information (8) such as a map or a photograph, and the audio information (9) such as a music or a voice guide can be transferred to the mobile communication system (B) that other person carries.

As known mobile telephone means, a PDC system and a CDMA system are considered herein. However, the PDC system and the CDMA system are used only in Japan and Korea and are particular systems from the global standpoint. In countries of Europe, Africa, Asia and Oceania, a GMS system is generally used. In the United States, both a digital system and an analog system are used mixedly. Further, a plurality of frequency bandwidths are utilized. Thus, the means for data communication needs to be considered in accordance with respective conditions. The most appropriate means should be selected depending on each area. Any cases selected may not cause troubles to carry out the present invention.

Then, a method for transferring the information to the system (F) having a function of the communication terminal that other person has by using a personal computer will be described.

When the necessary and/or optional information (G) provided at the information display member (A) is read (3), the information (G) is usually stored in the recording means (D) which is referred to as a memory and is provided in the mobile communication system (B). Then, as shown in FIG. 3, the present invention is configured to be connected to a net line from LAN. Thus, the information is transferred to a server (H) or any PC (I) via the Internet or a net line which includes wired or wireless LAN and/or stand-alone.

A file name which does not overlap each other is attached automatically to the information (G) transferred to the PC (I) by a program within the PC (I). By using any commercially available application software on an operating system Windows (Registered Trademark) supplied from Microsoft (Registered Trademark), predetermined text information can be added to the information (G) or the information (G) can be re-edited. Further, batch centralized management or processing can be carried out for the information (G).

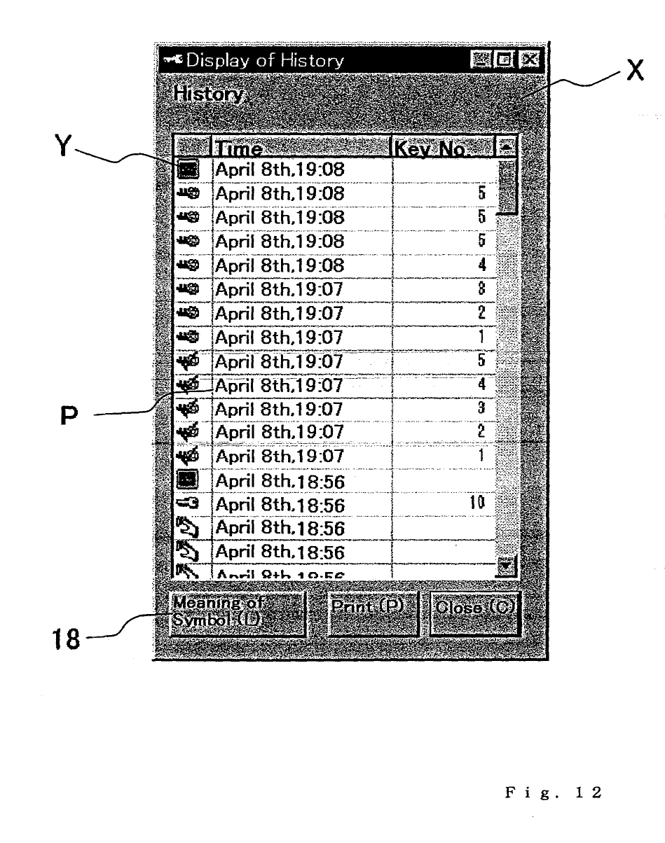

FIG. 12 is a menu screen (X) displayed on the PC (I). In the menu screen (X), the fetched information (G) is displayed as a list of history. Any data word (P) such as representative data included in a computer and a serial number is displayed on the list. The list preferably has a shell configuration for visual recognition. Further, as shown in FIG. 12, a type of a file may also be displayed. In a case of batch-managing plural kinds of files, as shown in FIG. 12, a program is formed such that a type of a file is displayed as an icon (Y), and definition of a symbol of the icon can be confirmed by clicking a button (18).

Although not shown in the drawings, representative any data such as a serial number, a date of recording, a place of recording, a file name, a file type, a user name, a climate at the time of recording, an order of recording and the like can be added to these files. In a case of inputting such data, an existing keyboard can be used as input means.

Further, although not shown in the drawings, it is preferable that a list can be sorted in an ascending order or in a descending order for respective categories such as file name and the like. It is preferable that a displayed image can be seen directly from a list screen by using an application software associated with an extension.

The various information (G) which has been subjected to processing and batch centralized management is transferred to another PC which has the same function as a PC which carries out the processing and the batch centralized management by using, for example, known electronic mail means. As a result, it is possible to transfer the text information (7) such as an address or a telephone number, the image information (8) such as a map or a photograph and the audio information (9) such as music or a voice guide.

Generally, in known electronic mail means, mail data is passed to a program of a machine which is referred to as sendmail and is designated in an SMTP server of a mailer (a tool of mail) The mail is delivered from the program to a destination host. Then, the mail is stored in a spool of the host. In sendmail, if a destination address is an address of a user's host, the following operations will be carried out.

1. Confirmation is carried out whether a user name is an alias. If so, the user name is rewritten and the mail is processed again.

2. If the user name is a user name of the host, the mail is added to a mail spool of the user.

If the destination address is not an address of a user's host, the following operations will be carried out.

1. sendmail.cf is confirmed. If a special processing with respect to the mail destination is designated, a processing is carried out in accordance with the special processing.

2. If the special processing is not designated, an MX record of a host name of the mail address is researched by using DNS. Then, the mail is transferred to the resultant host.

In order to receive mails stored in the spool, a POP3 is used. Instead of the POP3 server, an IMAP4 server can be used. The POP3 server is used to store mails delivered to a server in a disk of the server by a provider which provides connection service of personal computers. When a receiver accesses to receive mails, the provider supplies the mails to the receiver. When the IMAP4 server is used, the same information is duplicated so as to avoid waste of a storage capacity of the server. Further, in the IMAP4 server, required information can be searched in a server and only required portion thereof can be fetched. Basically, the IMAP4 server acts as the POP3 server. Thus, in this embodiment of the present invention, either the IMAP4 server or the POP3 server can be used.

The present invention can be carried out by using, instead of the Internet, a net line which includes a wired or wireless LAN and/or stand-alone.

As shown in FIG. 3, the information (G) stored in a PC (I) or in a server (H) can be copied to P.P. outputted from a printer connected to a personal computer. Further, the text information (7) such as an address or a telephone number, the image information (8) such as a map or a photograph and the audio information (9) such as a music or a voice guide can be copied to various kinds of recording mediums such as an FD, an MD and a DVD which are a portable storage medium.

Further, when the information is copied by utilizing the present system, necessary information can be added to the various information (G) or the information (G) can be processed. Thus, it is possible to form a database for images of commodities.

Specifically, when a database for commodity catalogs is formed or a clinical chart system is formed, shot images of commodities or affected areas of patients and commodity management codes or clinical chart data can be processed at the same time by activating an application software on an operating system Windows (Registered Trademark) provided by Microsoft (Registered Trademark). As a result, there is no need of, as conventional, forming shot images of commodities or affected areas and the commodity management codes or the clinical chart data separately and then combining and editing them.

As shown in FIG. 3, in the present invention, reading out the text information for blind persons is encompassed in a scope of the claims.

Finally, a description will be given of a function of “reading out” the text information for blind persons. An example of the reading out function includes a screen reader (reading out software) which is referred to as “JAWS for Windows V3.7” sold by Japan IBM.

Characteristics of the software are as follows.

1. In a dialog box which requires operation, it is possible to read out a title, conditions of operation items and help for the operation items.

2. It is possible to represent an application in voices by a script. The script is a kind of programs and is used to describe a method of reading out a content displayed on a screen and a format of a voice guide corresponding to an operation such as input from a keyboard or the like. Methods for utilizing the script are as follows.

(1) A default script used at a time of operating an usual application such as a memo pad.

(2) A dedicated script used together with the default script in a case of using a word processor software such as Word, a spreadsheet software such as Excel, a mail software, or a browser.

(3) A new script used in order that a user may produce a new script by using a script manager for the purpose of using a business application in an office or the like.

Any software may be used in the embodiment of the present invention as long as it has functions in accordance with the above-described functions.

The information display member (A) such as a poster is preferably provided with a signal member (Z) for notifying that the information recording element (R) exists. Accordingly, handicapped persons, as well as ordinary persons, can recognize the existence of the information display member (A). Examples of the signal member include a voice signal, an on-and-off light signal and a signal displayed by characters or figures. The signal may be used alone or in combinations of plural signals.

The mobile communication system (B) is preferably provided with the reader mechanism (V) which reads information recorded in the information recording element (R), the display portion (E) for displaying the information and means (Q) for detecting the signal member (Z). Any detection means (Q) may be used as long as it can detect remotely the existence of the signal member (Z) such as detecting means which utilizes electric communication by a satellite transponder.

Further, there are also included in a scope of claims of the present invention that a function of counting the number of information read from the information recording element (R) by using known means and recording of the number of counts in a recording medium such as a server system. As a counter, there has been conventionally used a counter using an SSI or a graphical access counter that an entire page is transformed into a CGI and outputted. Recently, there may be found a counter that an img tag is adhered to HTML. Any counter may be selected from these counters and disposed. If a system for computing the number of accesses every day is also incorporated, it is possible to compute the number of counts depending on a user's demand. For example, it is possible to compute yesterday's number of counts or today's number of counts.

As described above, in accordance with the present invention, information of an information recording element which is provided at an information display member such as a poster and to which necessary and/or optional information is inputted can be read by using input means which is provided in a mobile communication system. Further, the information can be recorded in recording means provided at the mobile communication system. Accordingly, there is no need of, as conventional, writing down the information on a memo pad with a writing tool. Particularly, information which is likely to be mistaken such as a telephone number or a map of a place or a so-called domain information with many characters such as a URL in the Internet or an e-mail address can be easily recorded.

Moreover, the information can be transferred to a mobile communication system that other person carries and/or to a system having a function of communication terminal. In the present invention, it is configured that a user can access to a net line from LAN. Alternatively, various information stored in a PC or in a server can be copied to P.P. outputted from a printer connected to a personal computer. Further, text information such as an address or a telephone number, image information such as a map or a photograph and audio information such as a music or a voice guide can be copied to various kinds of recording mediums such as an FD, an MD and a DVD which are a portable storage medium. As a result, the present invention accomplishes secondary or tertiary use of various information.

What is claimed is:

1. System for reading text display information comprising:
an information display member such as a poster; and
a mobile communication system for reading an information portion of said information display member;
wherein said information display member comprises an information recording element to which necessary and/or optional information of the information portion is inputted;
said mobile communication system comprises a reader mechanism for reading information recorded in said information recording element and a display portion for displaying the information.

2. The system for reading text display information according to claim 1, wherein said information recording element is storage means such as an IC chip and/or a bar code.

3. The system for reading text display information according to claim 1, wherein it is configured that information stored in said reader mechanism for reading information can be transferred to a mobile communication system other person carries and/or to a system having a function of communication terminal.

4. The system for reading text display information according to claim 1, wherein it is configured that the information stored in said reader mechanism for reading information can be connected to a net line from LAN.

5. The system for reading text display information according to claims 1 through 4, wherein the information stored in said reader mechanism for reading information can be recorded in a recording medium such as a server system.

6. The system for reading text display information according to claim 1, wherein text information and/or audio information and/or image information are inputted to said information recording element.

7. The system fore reading text display information according to claim 1, wherein the information stored in said reader mechanism for reading information can be copied.

8. The system for reading text display information according to claim 1 further comprising means for displaying in an enlarged manner a desired portion of the information displayed on said display portion provided at a main portion of said mobile communication system.

9. A system for reading text display information comprising:
an information display member such as a poster; and
a mobile communication system for reading an information portion of said information display member;
wherein said information display member comprises an information recording element to which necessary and/or optional information of the information portion is inputted and a signal member for notifying an existence of said information recording element;
said mobile communication system comprises a reader mechanism for reading information recorded in said information recording element, a display portion for displaying the information and means for detecting said signal member.

10. The system for reading text display information according to claim 9, wherein said signal member is selected from an audio signal, an on-and-off light signal or a signal displayed by characters or figures, or used in combinations thereof.

11. The system for reading text display information according to claim 1, wherein said information recording element has a function of counting the number that information is read.

12. The system for reading text display information according to claim 11, wherein the number of counts can be stored in a recording medium such as a server system.
